(19) United States
(12) Patent Application Publication
(10) Pub. No.: US 2026/0160852 A1
(43) Pub. Date: Jun. 11, 2026

(54) SYSTEMS AND METHODS FOR DETERMINING DEVICE LOCATION PROPERTIES USING CHANNEL STATE INFORMATION

(71) Applicant: SIGNIFY HOLDING B.V., EINDHOVEN (NL)

(72) Inventors: JIN YU, LEXINGTON, MA (US); PETER DEIXLER, ARLINGTON, MA (US); MUHAMMAD MOHSIN SIRAJ, EINDHOVEN (NL)

(21) Appl. No.: 18/838,683

(22) PCT Filed: Feb. 10, 2023
(86) PCT No.: PCT/EP2023/053374

§ 371 Date: Aug. 15, 2024

Related U.S. Application Data
(60) Provisional application No. 63/310,749, filed on Feb. 16, 2022.

(30) Foreign Application Priority Data
Mar. 7, 2022 (EP) 22160369.9

(51) Int. Cl. G01S 5/02; G01S 13/58; H04B 17/318; H04W 64/00

(52) U.S. Cl. CPC G01S 5/02523; G01S 13/587; H04B 17/318; H04W 64/006

(57) ABSTRACT

Systems and methods for determining device location properties of a wireless device, such as a smartphone, are provided. The system includes a processor configured to receive, via a plurality of wireless receivers arranged in a monitoring area, a wireless signal. The wireless signal is transmitted by the wireless device proximate to the subject. The wireless signal includes an identifier, such as a Bluetooth identifier, corresponding to the wireless device. The processor is further configured to determine CSI for a subject based on the received wireless signal. The processor is further configured to determine the one or more device location properties based on the determined CSI and a body-mass signature corresponding to the identifier. The one or more device location properties may include a relative location of the wireless device on the subject and/or an associated subject status.

### FIELD OF THE DISCLOSURE

The present disclosure is directed generally to systems and methods for determining device location properties using channel state information.

### BACKGROUND

Contact tracing smartphone applications share wireless identifying information (such as Bluetooth identifiers) with wireless receivers to evaluate potential close contacts. However, in some circumstances, an individual may accidentally pick up and carry a smartphone owned by another. This may occur in shared work areas (such as in an office or school) where the individuals use similar smartphones. This accidental carrying may then lead to contact tracing issues, as the wireless information shared by the contact tracing application corresponds to the owner of the phone, rather than the current carrier. Previously disclosed systems have attempted to address this problem by associating the identifying information with a heat signature corresponding to the owner of the phone. However, many sensor systems lack the high resolution heat sensors required to generate a thermal image of sufficiently high resolution for comparison to the heat signature. Accordingly, there is a need in the art for alternative systems and methods for ensuring a smartphone is being held by its rightful owner.

### SUMMARY OF THE DISCLOSURE

The present disclosure is directed to determining device location properties of a wireless device based on comparing channel state information (CSI) of a subject to a body-mass signature. CSI describes a how wireless signal transmitted by the device propagates to a plurality of wireless receivers, and may incorporate a variety of effects, such as losses, phase shifts, etc. Studies have shown that these effects correlate to, among other factors, the body mass index (BMI) of the subject through which the wireless signal passes. The measured CSI can be aggregated and processed to determine a body-mass signature for the subject. Thus, if a measured CSI of a subject corresponds to a known body-mass signature of a certain individual, the system may infer that the subject is the certain individual. Further, as measured CSI varies depending on the relative position of the wireless device on the user (such as front pocket or back pocket), the CSI may be used to determine relative position of the wireless device.

In one aspect, a plurality of wireless receivers, such as Bluetooth receivers, are arranged in a monitoring area, such as an office space. Each of the wireless receivers may be arranged in sensor bundles used in a connected lighting system. As a subject carrying a wireless device moves through the monitoring area, the wireless device transmits a radio frequency (RF) wireless signal, which is received by the wireless receivers. The wireless signal includes information identifying the wireless device, such as a Bluetooth identifier. The system then calculates the CSI corresponding to the subject based on the wireless signal received by the wireless receivers. The system may then determine various device location properties based on the determined CSI and one or more stored body-mass signatures. The stored body-mass signatures may correspond to individuals, or they may correspond to more general body types (tall and average BMI, short and low BMI, etc.). In one example, the system may determine if the subject is the rightful owner of the wireless device. If not, the system may generate an alarm signal and/or reduce the functionality of the wireless device, such as by locking the wireless device. Further, the system may utilize the CSI to determine the relative location of the wireless device on the subject.

Further, the aforementioned sensor bundles may include thermopile sensors configured to capture thermal data used to supplement the CSI to determine the device location properties. For example, thermal data of sufficient resolution may be used to estimate the location of subjects and their corresponding wireless devices. In the further examples, the thermal data may be used to determine the orientation of the subjects, such as the direction they are facing. The orientation of the subjects may be particularly useful in determining the relative location of the wireless device (such as in a front pocket, back pocket, right side pocket, left side pocket, backpack, handbag, etc.). In other examples, this location information may be based on commissioned layout data corresponding to the plurality of wireless receivers. When the wireless receivers are placed and commissioned, the commissioned layout data stores the placement of the wireless receivers.

The body-mass signatures used to compare with the measured CSI may be generated by the system as part of a training scheme. Similar to the monitoring area described above, a plurality of the wireless training receivers may be placed in a training area. The training area may be an entrance way, aisle, stairwell, security checkpoint, or other area where a subject will almost certainly be carrying their wireless device. In the training area, the wireless training receivers receive a wireless training signal transmitted by the wireless device. The wireless training signal includes an identifier, such as a Bluetooth identifier. The received wireless training signals are processed to determine CSI for each transmission. The CSI are then aggregated and processed to create a body-mass signature. The body-mass signature is then associated with the identifier, such that the identifier may be used to retrieve the body-mass signature corresponding to the subject. The association of the body-mass signature to the identifier may then be stored in memory. In some examples, rather than generating body-mass signatures for every expected subject, the memory may store an array of stock body-mass signatures corresponding to different body types and BMIs.

Further, the training sensor bundles may include training thermopile sensors configured to capture thermal training data used to supplement the CSI to determine the body-mass signature. For example, thermal training data of sufficient resolution may be used to estimate the location of subjects and their corresponding wireless devices. In further examples, the thermal training data may be used to determine the orientation of the subjects, such as the direction they are facing. The orientation of the subjects may be particularly useful in determining the relative location of the wireless device on the subject (such as in a front pocket, back pocket, backpack, handbag, etc.). In gathering training CSI to generate a body-mass signature, the training CSI corresponding to wireless signals passing through the subject are the most relevant. Accordingly, by determining the relative location of the wireless device on the subject, the thermal training data may be used to determine the importance of the different aspects of the training CSI.

In many cases, the subject is a human individual carrying a wireless device, such as a smartphone, tablet computer, smartwatch, smart glasses, etc. Thus, the systems and methods may be used to track the location of the subject, determine the relative location of the wireless device on the subject, and ensure that the subject is the rightful owner of the wireless device. In further examples, the subject may be an animal wearing an active wireless tracking tag. In this example, the systems and methods may be used to track the location of the animal, determine the relative location of the wireless device on the animal, and ensure that the tracking tag is worn by the correct animal. This example may be further extended to inanimate objects for shipment tracking or inventory control.

Generally, in one aspect, a system for determining one or more device location properties of a wireless device is provided. In one example, the wireless device is a smartphone.

The system includes a processor. The processor is configured to receive, via a plurality of wireless receivers arranged in a monitoring area, a wireless signal. According to an example, the plurality of wireless receivers are Bluetooth receivers or ultrawideband (UWB) receivers.

The wireless signal is transmitted by the wireless device proximate to a subject. The wireless signal includes an identifier. The identifier corresponds to the wireless device.

The processor is further configured to determine CSI for the subject. The CSI is based on the received wireless signal.

The processor is further configured to determine the one or more device location properties based on the determined CSI and a body-mass signature. The body-mass signature is associated with the identifier. In one example, the one or more device location properties include a relative location of the wireless device on the subject. The relative location may correspond to one of the a front pocket of the subject, a back pocket of the subject, a handbag of the subject, or a backpack of the subject. In another example, the one or more device location properties include an associated subject status.

According to an example, the processor is further configured to generate an alarm signal. The alarm signal is generated based on the associated subject status. According to a further example, the processor is further configured to limit one or more operational aspects of the wireless device based on the associated subject status.

According to an example, the one or more device location properties are further based on commissioned layout data. The commissioned layout data corresponds to the plurality of wireless receivers.

According to an example, the processor is further configured to receive thermal monitoring data. The thermal monitoring data is collected by a thermopile monitoring sensor. The thermal monitoring sensor is arranged in the monitoring area. In this example, the one or more device location properties are further based on the thermal monitoring data.

According to an example, the processor is further configured to receive, via a plurality of wireless training receivers arranged in a training area, a wireless training signal. The wireless training signal is transmitted by the wireless device. The wireless training signal includes the identifier. The processor is further configured to determine training CSI based on the received wireless training signal. The processor is further configured to determine, based on the training CSI, the body-mass signature. The processor is further configured to associate the body-mass signature with the identifier.

According to an example, the processor is further configured to receive thermal training data. The thermal training data is collected by a thermopile training sensor. The thermopile training sensor is arranged in the training area. Alternatively, the processor is further configured to receive light detection and ranging (LIDAR) training data. The LIDAR training data is collected by a LIDAR training sensor. The LIDAR training sensor is arranged in the training area. In this example, the body-mass signature is further based on the thermal data or the LIDAR training data.

Generally, in another aspect, a method for determining one or more device location properties of a wireless device is provided. The method includes receiving, via a plurality of wireless receivers arranged in a monitoring area, a wireless signal transmitted by the wireless device proximate to the subject, wherein the wireless signal includes an identifier corresponding to the wireless device. The method further includes determining CSI for a subject based on the received wireless signal. The method further includes determining the device location properties based on the determined CSI and a body-mass signature, wherein the body-mass signature corresponds to the identifier.

According to an example the method may further include receiving, via a plurality of wireless training receivers arranged in a training area, a wireless training signal transmitted by the wireless device, wherein the wireless training signal includes the identifier. The method may further include determining training CSI based on the received wireless training signal. The method may further include determining, based on the training CSI, the body-mass signature. The method may further include associating the body-mass signature with the identifier.

In various implementations, a processor or controller can be associated with one or more storage media (generically referred to herein as “memory,” e.g., volatile and non-volatile computer memory such as ROM, RAM, PROM, EPROM, and EEPROM, floppy disks, compact disks, optical disks, magnetic tape, Flash, OTP-ROM, SSD, HDD, etc.). In some implementations, the storage media can be encoded with one or more programs that, when executed on one or more processors and/or controllers, perform at least some of the functions discussed herein. Various storage media can be fixed within a processor or controller or can be transportable, such that the one or more programs stored thereon can be loaded into a processor or controller so as to implement various aspects as discussed herein. The terms “program” or “computer program” are used herein in a generic sense to refer to any type of computer code (e.g., software or microcode) that can be employed to program one or more processors or controllers.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

These and other aspects of the various embodiments will be apparent from and elucidated with reference to the embodiment(s) described hereinafter.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the various embodiments.

FIG. 1 is a probability density distribution graph of body-mass index (BMI) and transmission path gain, in accordance with an example.

FIG. 2 is an illustration of aspects of the system arranged in a monitoring area, in accordance with an example.

FIG. 3 is an illustration of aspects of the system arranged in a training area, in accordance with an example.

FIG. 4 is an illustration of a database pairing identifiers with body-mass signatures and thermal profiles, in accordance with an example.

FIG. 5 is a schematic illustration of aspects of a monitor, in accordance with an example.

FIG. 6 is a flowchart of a method for determining one or more device location properties, in accordance with an example.

### DETAILED DESCRIPTION OF EMBODIMENTS

The present disclosure is directed to determining device location properties of a wireless device based on comparing channel state information (CSI) of a subject to a body-mass signature. CSI describes a wireless signal transmitted by the device propagates to a plurality of wireless receivers, and may incorporate a variety of effects, such as losses, phase shifts, etc. Studies have shown that these effects correlate to, among other factors, the body mass index (BMI) of the subject through which the wireless signal passes. The measured CSI can be aggregated and processed to determine a body-mass signature for the subject. Thus, if a measured CSI of a subject corresponds to a known body-mass signature of an individual, the system may infer that the subject is the individual. Further, as measured CSI varies depending on the relative position of the wireless device on the user (such as front pocket or back pocket), the CSI may be used to determine the relative position of the wireless device.

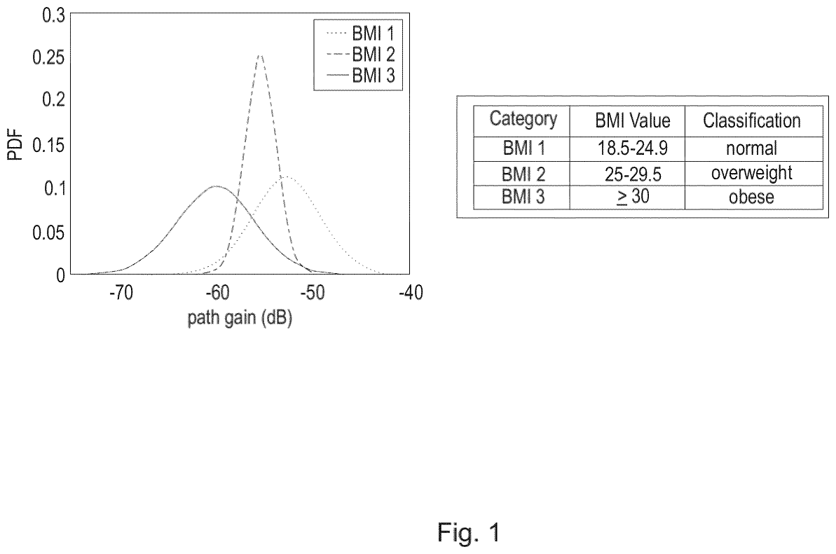

FIG. 1 is a probability density distribution graph of BMI and transmission path gain. The graph includes three BMI ranges: 18.5-24.9 (classified as “normal”), 25.0-29.5 (classified as “overweight”) and ≥30 (classified as “obese”). Each range correlates to a different probability density function (PDF). The plotted PDF of each BMI range represents the relative likelihood of the gain experienced by a radio frequency (RF) signal passing through a subject. For example, if the subject is a person of “normal” BMI, it is most likely that an RF signal passing through the subject would experience a gain of approximately −52 dB. In a further example, if the subject is a person of “overweight” BMI, it is most likely that an RF signal passing through the subject would experience a gain of approximately −55 dB. In an even further example, if the subject is a person of “obese” BMI, it is most likely that an RF signal passing through the subject would experience a gain of approximately −61 dB.

Further, the potential range of gain is also impacted by BMI. For example, the range of transmission gain for a subject of “normal” BMI has a transmission path gain range of approximately −42 dB to −65 dB. Further, the range of transmission gain for a subject of “overweight” BMI has a transmission path gain range of approximately −50 dB to −62 dB. Even further, the range of transmission gain for a subject of “obese” BMI has a transmission path gain range of approximately −47 dB to −75 dB. These measurable correlations between BMI and transmission path gain enable the probabilistic prediction of the identity of a subject based on the transmission path gain they impose on RF signals.

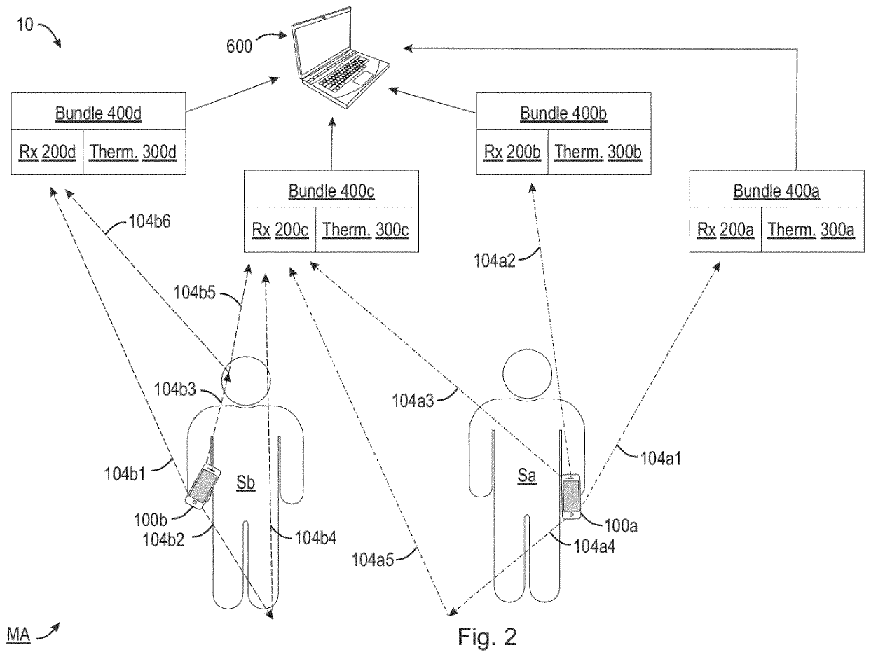

FIG. 2 is an illustration of a system 10 for determining one or more device location properties 102 of a wireless device 100 relative to a subject S arranged in a monitoring area MA. As shown in FIG. 2, the system 10 includes four sensor bundles 400a-400d. Each of the sensor bundles 400a-400d may be embedded or used with a connected lighting system. Each sensor bundle 400a-400d includes a receiver 200a-200d and a thermopile sensor 300a-300d. In one example, the receivers 200a-200d are configured to receive wireless signals 104a1-104b6 transmitted by the wireless devices 100a, 100b, such as Bluetooth receivers or ultrawideband (UWB) receivers. The wireless signals 104a1-104b6 are RF signals configured to carry an identifier 106a, 106b (not shown). The identifier 106a, 106b represents the wireless device 100a, 100b transmitting the wireless signal 104a1-104b6 received by the receiver 200a-200d. In one example, the identifier 106a, 106b may be a Bluetooth identifier, such as a Bluetooth device address assigned to the corresponding wireless device 100a, 100b during manufacturing. The identifier 106 can indicate the owner (e.g., rightful owner) of the respective wireless device 100 represented by the identifier 106. In embodiments, the identifier 106 can be linked with or associated with the owner of the respective wireless device 100 represented by the identifier 106, for example, in the database 150.

In the example of FIG. 2, a first subject Sa holds a first wireless device 100a on the left side of their body. The first wireless device 100a is assigned a first identifier 106a. The first wireless device 100a transmits wireless signals 104a1-104a5. Each of the wireless signals 104a1-104a5 carries the first identifier 106a. Accordingly, the first identifier 106a allows the wireless signals 104a1-104a5 to be identified as transmitted by the first wireless device 100a.

Further to the example of FIG. 2, a second subject Sb holds a second wireless device 100b on the right side of their body. The second wireless device 100b is assigned a second identifier 106b. The second wireless device 100b transmits wireless signals 104b1-104b6. Each of the wireless signals 104b1-104b6 carries the second identifier 106b. Accordingly, the second identifier 106b allows the wireless signals 104b1-104b6 to be identified as transmitted by the second wireless device 100b.

The sensor bundles 400a-400b further include thermopile monitoring sensors 300a-300d. Each of the thermopile monitoring sensors 300a-300d are configured to capture heat map information for certain portions of the monitoring area MA. This heat map information may be aggregated into thermal monitoring data 124 of the entire monitoring area MA. The thermal monitoring data 124 may include an array of pixels indicating varying temperatures found within the monitoring area MA. For example, a portion of the thermal monitoring data 124 corresponding to a human subject S or an active wireless device 100 will indicate a higher temperature than a piece of furniture. Accordingly, the thermal monitoring data 124 may be used to estimate presence, location, and orientation of the subjects Sa, Sb and the wireless devices 100a, 100b within the monitoring area MA. For example, the orientation of the subjects Sa, Sb may be determined based on a pattern of movement within the monitoring area MA, as a subject S moving across a room may be assumed to facing in the direction of their movement. In other examples, the orientation of the subject S may be based on exhalations found in the thermal monitoring data 124.

In some examples, at least one of the one or more thermopile sensors 300a-300d may be a single pixel thermopile (SPT) sensor with low resolution (for example, as high as 3 meters). In these examples, the amount of useful information provided by the thermopile sensors 300a-300d is limited. Accordingly, the system 10 may use alternate means, such as commissioned layout data 128, identifiers 164, and CSI 108 to determine presence and location of the subjects Sa, Sb and the wireless devices 100a, 100b.

In a preferred example, at least one of the one or more thermopile monitoring sensors 300a-300b may be a multipixel thermopile (MPT) sensor. The MPT sensors typically have much higher resolution (for example, as low as 10 centimeters) than SPT sensors, and can therefore be used to determine the presence, location, and orientation of the subjects Sa, Sb and the wireless devices 100a, 100b.

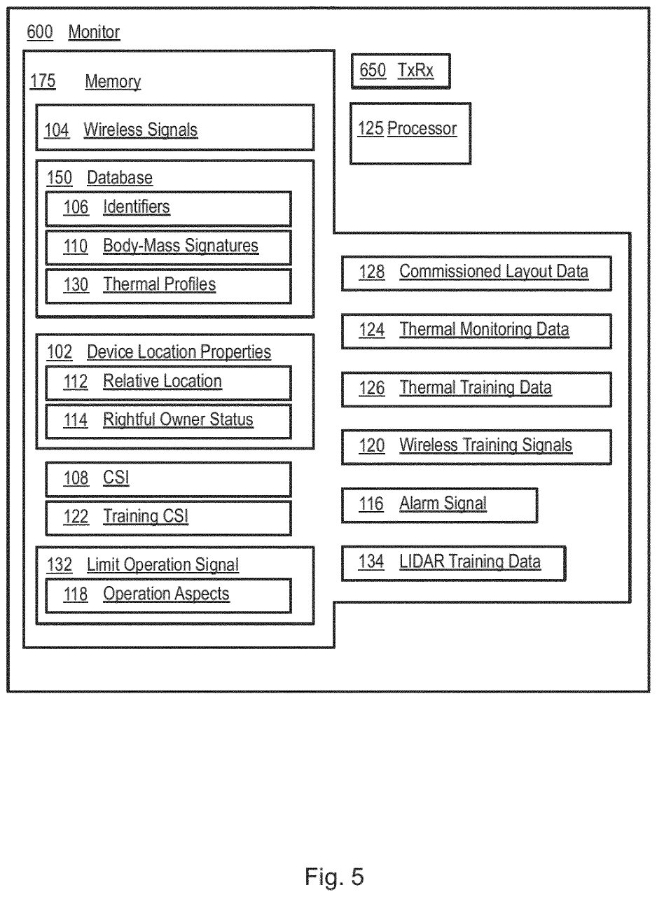

Each of the sensor bundles 400a-400d are communicatively coupled to a monitor 600 via any combination of wired and/or wireless connections. The monitor 600 includes processor 125 and memory 175 (shown in FIG. 5). The monitor 600 is configured to receive, store, and process the wireless signals 104a1-104b6 captured by the receivers 200a-200d and the thermal monitoring data 124 captured by the thermopile monitoring sensors 300a-300d. The monitor 600 may be any type of computing device, such as a desktop computer, laptop computer, server, etc. The monitor 600 may be positioned locally or remotely to the monitoring area MA.

In some examples, one or more of the receivers 200a-200d and/or the thermopile sensors 300a-300d may be arranged apart from the sensor bundles 400a-400d in a discrete manner. In these examples, the receivers 200a-200d and/or thermopile monitoring sensors 300a-300d may be directly communicatively coupled to the monitor 600.

As will be explained in greater detail below, the monitor 600 uses the wireless signals 104a1-104b6 to determine CSI 108a, 108b corresponding to each subject Sa, Sb. As described in relation to FIG. 1, wireless signals 104a1-104b6 travelling through the physical bodies of the subjects Sa, Sb will experience losses. These losses correlate to the BMI of each subject Sa, Sb. The monitor 600 may then compare the CSI 108a, 108b for each Sa, Sb to stored body-mass signatures 112 to determine one or more device location properties 102, such as the relative location 112 of the wireless device 100 or an associated subject status 114. The relative location 112 indicates the location of the wireless device 100 on the subject S carrying it. The relative location 112 may characterize the wireless device 100 as being carried in the front pocket, back pocket, right-side handbag, left-side handbag, backpack etc., of the subject S. The associated subject status 114 indicates if the wireless device 100 is currently being carried by its rightful owner by comparing the CSI 108 measured for the wireless device 100 to a stored body-mass signature 110 associated with the identifier 106 of the wireless device 100. The device location properties 102 may include additional information regarding the location of the wireless device 100. For example, the device location properties 102 may indicate coordinate location information, global positioning system (GPS) information, latitude and longitude values, location within a particular building or structure, location relative to other wireless devices 100, location relative to aspects of a connected lighting system (such as sensor bundles 400), change in location over time, and more.

As shown in FIG. 2, the first wireless device 100a transmits wireless signals 104a1-104a4. A person having ordinary skill in the art would understand that this diagram and description is solely for illustrative purposes. The first subject Sa holds the wireless device 100a in their left hand. Due to the positioning of the wireless device 100a and the first subject Sa, wireless signal 104al travels from the wireless device 100a to the first receiver 200a without being impacted by the body of the first subject Sa. Thus, wireless signal 104al will not provide helpful information to the monitor 600 to determine the CSI 108a of the first subject Sa. Conversely, wireless signals 104a2, 104a3 both pass through the first subject Sa before being captured by the second receiver 200b and the third receiver 200c, respectively. Therefore, wireless signals 104a2, 104a3 will provide helpful information to the monitor 600 to determine the CSI 108a of the first subject Sa. Wireless signal 104a4 travels through the body of the first subject Sa, and then reflects off the ground as wireless signal 104a5. The wireless signal 104a5 is then received by the third receiver 200c. As the wireless signal 104a4 travelled through the body of the first subject Sa prior to reflection off the ground, the wireless signal 104a5 incorporates the body-mass impact (transmission loss, reflection, scatter, delay, etc.) of the subject Sa on wireless signal 104a4. This body-mass impact enables the system 10 to determine the CSI 108a of the first subject Sa. Wireless signals 104a3-104a5 illustrate example multipath transmissions between the first wireless device 100a and the third receiver 200c.

As also shown in FIG. 2, the second wireless device 100b transmits wireless signals 104b1-104b4. A person having ordinary skill in the art would understand that this diagram and description is solely for illustrative purposes. The second subject Sb holds the second wireless device 100b in their right hand. Due to the positioning of the second wireless device 100b and the second subject Sb, wireless signal 104b1 travels from the wireless device 100b to the fourth receiver 200d without being impacted by the body of the second subject Sb. Thus, wireless signal 104b1 will not provide helpful information to the monitor 600 to determine the CSI 108b of the second subject Sb. Conversely, wireless signals 104b2, 104b3 both pass through the second subject Sb before being captured by the third receiver 200c and the fourth receiver 200d, respectively. While passing through the second subject Sb, wireless signal 104b3 splits into wireless signal 104b5, received by the third receiver 200c, and wireless signal 104b6, received by the fourth receiver 200d. Therefore, wireless signals 104a5, 104a6 will provide helpful information to the monitor 600 to determine the CSI 108b of the second subject Sb. Wireless signal 104b2 travels through the body of the second subject Sb, and then reflects off the ground as wireless signal 104a4. The wireless signal 104b4 then travels through the body of the second subject Sb, and is received by the third receiver 200c. As the wireless signal 104b4 travelled through the body of the second subject Sa prior to reflection, and wireless signal 104b4 travelled through the body of the second subject after reflection, the wireless signal 104b4 will also provide helpful information to determine the CSI 108b of the first subject Sb.

The CSI 108 between receivers 200 and wireless devices can be defined by Equation 1 as follows:

$$[ \begin{matrix}{y}_{0} \\ … \\ {y}_{N - 1}\end{matrix} ] = [ \begin{matrix}{h}_{0 , 0} & … & {h}_{0 , M - 1} \\ … & … & … \\ {h}_{N - 1 , 0} & … & {h}_{N - 1 , M - 1}\end{matrix} ] [ \begin{matrix}{x}_{0} \\ … \\ {x}_{M - 1}\end{matrix} ] + [ \begin{matrix}{n}_{0} \\ … \\ {n}_{M - 1}\end{matrix} ] \qquad ( 1 )$$

where x_{M} are the wireless signals 106 transmitted by M wireless devices 100, y_{N} are the wireless signals 106 received at N receivers 200, h_{N,M} is the CSI 108 between the M wireless devices 100 and N receivers 200, and n_{M} is the noise experienced by the wireless signals 106 when transmitted by M wireless devices 100. As will be described below, the system 10 may be configured to focus analysis on the h_{N,M} elements where at least a portion of the subject S is between the wireless device 100 and the receiver 200. The CSI 108 corresponding to i receiver 200 and j wireless device 100 may be defined by Equation 2 as follows:

$${h}_{i , j} = f ( {L}_{i} , {P}_{j} , {B}_{j} ) \qquad ( 2 )$$

where Lᵢ is the position of the receiver 200, Pⱼ is the position of the subject S, and Bⱼ is the position of the wireless device 100. In some examples, Pⱼ and Bⱼ are determined by analyzing thermal monitoring data 124 collected by the thermopile monitoring sensors 300, specifically multipixel thermopile arrays. Lᵢ, Pⱼ, and Bⱼ can then be used to determine if the subject S is located between the receiver 200 and the wireless device 100. If so, the wireless signal 104 captured at the receiver 200 may be used to determine CSI 108 for the subject S.

In alternate examples, the determination of the position of the receiver 200 and the position of the wireless device 100 may be determined using commissioned layout data 128. When the receivers 200 are commissioned throughout the monitoring area MA, they may be both physically arranged and electronically configured. As part of the commissioning process, the physical location of the receivers 200 may be stored as part of the commissioned layout data 128. For example, the commissioned layout data 128 can include or indicate the location and/or position data of one or more receivers 200 located within an area (e.g., monitoring area MA) or environment as determined and identified during the commissioning process. Thus, Lᵢ may be obtained by retrieving positions of the receivers 200 from the commissioned layout data 128. The locations of the wireless device 100 may be then determined by triangulating the wireless signals 104 transmitted by the wireless devices 100 and received by the receivers 200.

Further, the CSI 108 can also be described in Equation 3 as follows:

$${h}_{i , j} = f ( {d}_{i , j} , {BM}_{j} ) \qquad ( 3 )$$

where BMⱼ is a body-mass impact of a jth subject S, and d_{i,j} is the distance from the ith receiver 200 to the jth wireless device 100. Accordingly, a probability density function of h_{i,j} conditioned on the body-mass impact BMⱼ may be defined in Equation 4 as follows:

$$P ( {h}_{i , j} \vert {BM}_{j} ) = Prob ( {d}_{i , j} , {BM}_{j} ) \qquad ( 4 )$$

When a wireless device 100 is picked up and carried by a subject S through the monitoring area MA, the system 10 can infer the body-mass impact BM of the subject S from time series data of wireless signals 104 captured by the receivers 200. The probability of the rightful owner carrying the wireless device 100 can be determined by Equations 5 and 6 as follows:

$$Prob ( {BM}_{j} \vert {h}_{i , j} , i = 0 , … , K - 1 ) = \frac{Prob ( {h}_{i , j} \vert BM , i = 0 , … , K - 1 )}{P ( BM )} \qquad ( 5 )$$

$$BM == {BM}_{j} ? \qquad ( 6 )$$

Accordingly, the CSI 108 between K different receivers 200 and the wireless device 100 may be combined. From the combined CSI 108, the total body-mass impact BM of the subject can be determined. The total body-mass impact BM of the subject may then be compared to a stored body-mass signature 110 associated with the identifier 106 embedded in the wireless signals 104. Based on this comparison, the system 10 determines the associated subject status 114 of the wireless device 100.

In some examples, the determination of associated subject status 114 may be aided by stored thermal profiles 130 corresponding to the stored body-mass signatures 110 and the identifiers 106. A thermal profile 130 describes the temperature characteristics of a particular subject S associated with an identifier 106. If the subject S is a human, non-human animal, or a powered device (such as a robot), the subject S will generate heat in a pattern particular to the physical properties of the subject S. These thermal profiles 130 may then be used to identify the subject S. The thermal profiles 130 may contain feature data such as cluster area, peak temperature, etc. A cluster area is defined by a group of pixels of similar temperatures within the thermal profile 130. If the subject S is a human, a group of pixels of near human body temperature can be used to define the overall shape of the subject S. Similarly, peak temperature captures the hottest temperature for a particular pixel over time. Various different types of subjects S may have different peak temperatures. For instance, pixels corresponding to a human will likely have a different peak temperature than pixels corresponding to a non-human powered device. The system 10 may then also compare thermal monitoring data 124 captured by the thermopile monitoring sensors 300 to the thermal profiles 130 to determine the associated subject status 114.

If the associated subject status 114 indicates that the subject S is the rightful owner of the wireless device 100, typically, no further action is required. However, if the associated subject status 114 indicates that the wireless device 100 is being carried by a subject S other than the rightful owner, the monitor 600 may generate one or more responses. In one example, the response may be the wireless device 100 generating an alarm signal 116. The alarm signal 116 may be embodied in a number of different ways. For example, the alarm signal 116 may trigger the monitor 600 and/or the wireless device 100 to provide visual or audio notification(s). Further, the alarm signal 116 may be transmitted to remote monitoring devices to inform remote individuals that the wireless device 100 in the monitoring area MA is being carried by a non-owner subject S.

In another example, the response may be generating, by the monitor, a limit operation signal 132. The limit operation signal 132 is configured to limit one or more operational aspects 118 of the wireless device 100 when the system 10 learns that the wireless device 100 is being carried by a subject S other than the rightful owner. In one example, the limit operation signal 132 locks the user interface (such as a touchscreen) of the wireless device 100. In another example, the limit operation signal 132 limits access to certain sensitive applications and/or files, such as banking applications, e-mail applications, texting applications, etc. In other examples, the limit operation signal 132 may restrict use of certain hardware of the wireless device 100, such as a camera, speaker, or microphone.

In some examples, the CSI 108 is used to determine the relative location 112 of the wireless device 100 on the subject S. In one example, the relative location 112 of the wireless device 100 may be determined by analyzing the CSI 108 to determine which wireless signals 104 experience losses due to body-mass impact. For example, if the CSI 108 indicates no body-mass impact on a wireless signal 104 captured by a first receiver 200 to the back of the subject S, and also indicates significant body-mass impact on a wireless signal 104 captured by a second receiver to the front of subject S, the system 10 may determine that the wireless device 100 is in a back pocket of the subject S. This determination may be aided by analyzing thermal monitoring data 124 to determine the orientation of the subject S, i.e., determining which way is the subject facing. For example, the orientation of the subject S may be determined based on a pattern of movement within the monitoring area MA, as a subject S may be assumed to facing in the direction of their movement. In other examples, the orientation of the subject S may be based on exhalations detected in the thermal monitoring data 124, as the subject S is presumed to be facing in the direction of their exhalations.

In the example of FIG. 2, each wireless device 100 includes a single antenna configured to transmit a wireless signal 104. However, in some further examples, each wireless device 100 may include more than one antenna. For example, if the wireless device 100a is embodied as a smartphone, the wireless device 100a may include a first antenna positioned on the front side of the smartphone configured to transmit wireless signal 104a1, and a second antenna positioned on the back side of the smartphone configured to transmit wireless signal 104a2. The wireless signals 104a1, 104a2 are captured by a wireless receiver 200. A processor 125 may then analyze the wireless signals 104a1, 104a2 to determine the orientation of the smartphone. For instance, if wireless signal 104al is received by the wireless receiver 200 after wireless signal 104a2, then the back side of the smartphone is likely facing the wireless receiver 200. With this knowledge, the processor 125 may then analyze the thermal monitoring data 124 to determine which antenna faces subject S. The system 10 may then select the antenna facing the subject S to determine CSI 108 corresponding to the subject S. Utilizing the antenna facing the subject S will maximize the impact of the body of subject S on the transmitted wireless signal 104, and therefore will also maximize the impact of the body of subject S on the CSI 108 derived from the transmission and reception of the wireless signal 104.

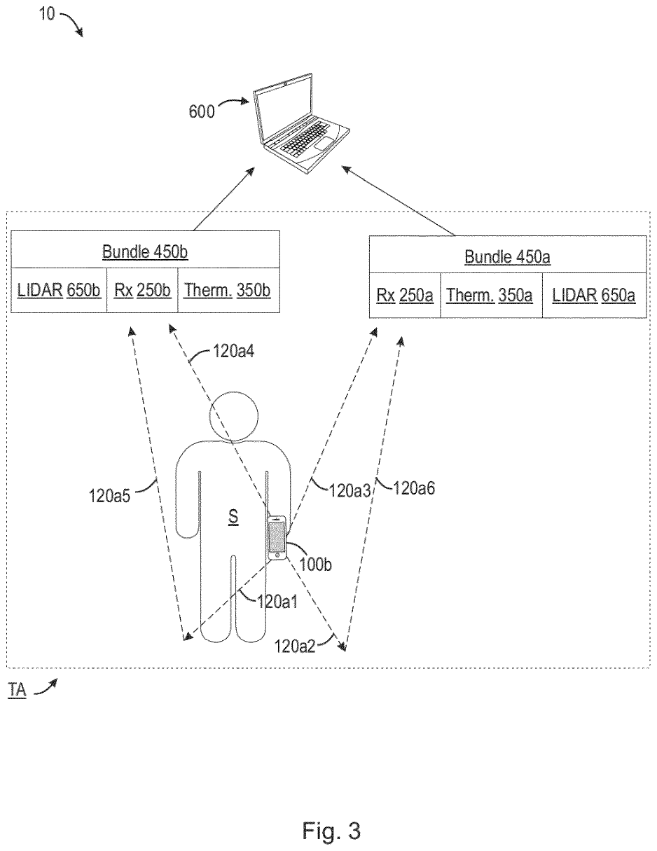

FIG. 3 is an illustration of further aspects of system 10. These aspects are directed to determining a body-mass signature 110 for subject S located in a training area TA based on training CSI 122. The training area TA is preferably a highly trafficked area in which the subjects S will be carrying their corresponding wireless device 100. For example, if the monitoring area MA includes part of an office building, the training area TA may be an entrance way, aisle, stairway, security checkpoint, corridor, lobby, elevator, or break-room.

FIG. 3 shows two training sensor bundles 450a, 450b communicatively coupled to a monitor 600 via any combination of wired and/or wireless connections. Each training sensor bundle 450a, 450b includes a corresponding training receiver 250a, 250b, a corresponding thermopile training sensor 350a, 350b, and a corresponding light detection and ranging (LIDAR) training sensor 650a, 650b. Each of the training sensor bundles 450a-450d may be embedded or used with a connected lighting system. The training receivers 250a, 250b are configured to receive wireless training signals 120a1-120a4 transmitted by wireless device 100. In some examples, the wireless training signals 120a1-120a4 are the same as the wireless signals 104 illustrated in FIG. 2. The wireless signals 120a1-120a4 are RF signals configured to carry an identifier 106 (not shown). The identifier 106 represents the wireless device 100 transmitting the wireless training signals 120a1-120a4 received by the receivers 250a, 250b. As with the example of FIG. 2, the identifier 106 may be a Bluetooth identifier, such as a Bluetooth device address assigned to the wireless device 100 during manufacturing.

As also shown in FIG. 3, the wireless device 100 transmits wireless signals 104a1-104a4. A person having ordinary skill in the art would understand that this diagram and description is solely for illustrative purposes. The subject S holds the wireless device 100 in their left hand. Due to the positioning of the wireless device 100 and the subject S, wireless training signal 120a3 travels from the wireless device 100 to the first training receiver 250a without being impacted by the body of the subject S. Further, wireless training signal 120a2 is reflected off the floor as wireless training signal 120a6 without passing through the body of the subject S. Thus, wireless training signals 120a2, 120a3, 120a6 will not provide helpful information to the monitor 600 to determine the training CSI 122 of the subject S. Conversely, wireless training signals 120a1, 120a4 both pass through the first S before being captured by the second training receiver 200b. Wireless training signal 120a4 is reflected off the floor as wireless training signal 120a5 before being captured by the second training receiver 250b. Thus, wireless training signals 120a1, 120a4, 120a5 will provide helpful information to the monitor 600 to determine the training CSI 122 of the subject S.

The sensor training bundles 450a, 450b further include thermopile training sensors 350a, 350b. The thermopile training sensors 350a, 350b are configured to capture thermal training data 126 of the training area TA. The thermal training data 126 may be used to estimate presence and location of the subject S and the wireless device 100. The thermal training data 126 may also be used to estimate the orientation of the subject S. In further examples, the thermal training data 126 may be used to derive thermal profile 130 for the subject S. The thermal profile 130 may include properties such as cluster area, peak temperature, etc. The thermal profile 130 may be associated with the identifier 106 of the wireless device 100. In a preferred example, at least one of the thermopile training sensors 350a, 350b may be an MPT sensor.

The sensor training bundles 450a, 450b further includes LIDAR training sensors 650a, 650b. The LIDAR training sensors 650a, 650b are configured to capture LIDAR training data 134. The LIDAR training data 134 may be a point cloud mapping the aspects of the training area (TA), including subject S. Like the thermal training data 126, the LIDAR training data 134 may be used to estimate the orientation of the subject S.

Once the monitor 600 has retrieved the wireless training signals 120a1-120a6, the system 10 may determine the training CSI 122 according to Equation 1. The system may then generate a body-mass signature 110 for subject S according to Equations 2-6. The body-mass signature 110 is associated with the identifier 106 of the wireless device 100.

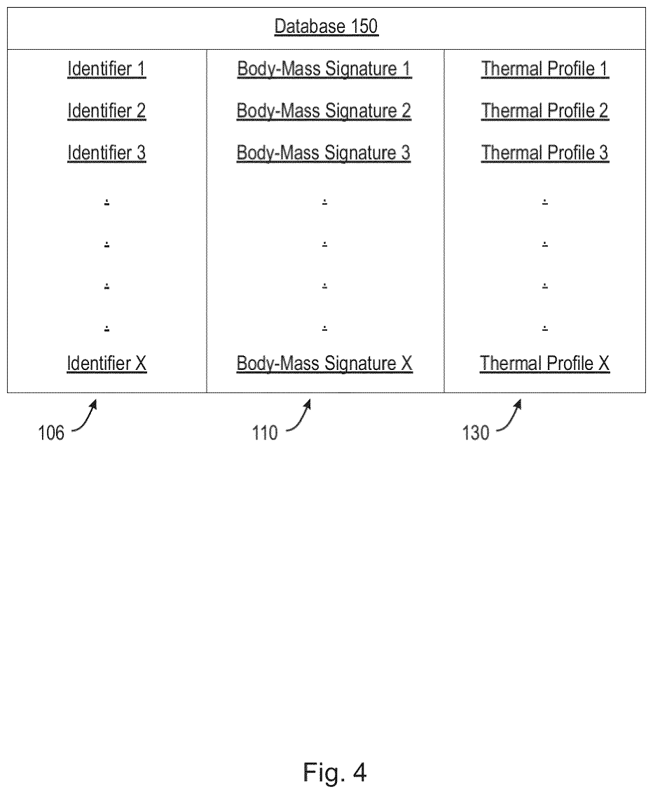

FIG. 4 illustrates a database 150 storing the relationships between associated identifiers 106 (such as Bluetooth identifiers) and body-mass signatures 110. When a subject S carrying a wireless device 100 is under analysis, the system 10 extracts an identifier 106 from the wireless signals 104 transmitted by the wireless device 100. Using the identifier 106, the system 10 can retrieve a body-mass signature 110, derived from training CSI 124, to compare with the CSI 108 of the subject S carrying the wireless device 100 to determine an associated subject status 114. In some examples, the body-mass signatures 110 are not derived directly from training CSI 124, but are more general body-mass signatures 110 corresponding to certain body-types and/or characteristics (tall and average BMI, short and low BMI, etc.).

In some examples, the database 150 also stores the relationships between associated identifiers 106 and thermal profiles 130. The thermal profile 130 describes the temperature characteristics of a particular subject S associated with an identifier 106 as a result of the training process. For example, if the subject S is a human, non-human animal, or a powered device (such as a robot), the subject S will generate heat in a pattern particular to the physical properties of the subject S. This pattern may be captured as the thermal profile 130 during training. In this example, the associated subject status 114 may further depend on the comparison of the thermal profile 130 associated with the extracted identifier 106 and the captured thermal monitoring data 124.

In some examples, the system 10 and/or monitor 600 may update the database 150 on a periodic or continuous basis. These updates may correspond to new subjects S passing through transition area TA. As part of these updates, new entries may be added to the database 150 associating identifiers 106 with body-mass signatures 110 and/or thermal profiles 130. These new entries may be added when the system 10 recognizes identifiers 106 or body-mass signatures 110 not found in the current database. Further, in some examples, the existing entries may be updated to revise the body-mass signature 100 or thermal profile 130 associated with a particular identifier 106.

FIG. 5 schematically illustrates aspects of monitor 600. The monitor 600 includes a processor 125, memory 175, and a transceiver 650. The monitor 600 uses the transceiver 650 to receive wireless signals 104, wireless training signals 120, thermal monitoring data 124, and thermal training data 126. The processor 125 extracts identifiers 106 from the wireless training signals 120. The processor 125 determines training CSI 122 based on wireless training signals 120 and/or thermal training data 126. The processor 125 then determines the body-mass signatures 110 for each identifier 106 based on the training CSI 122. The processor 125 may also generate thermal profiles 130 based on each identifier 106 based on the thermal training data. The processor 125 stores associated identifiers 106, body-mass signatures 110, and thermal profiles in database 150.

The processor 125 then determines device location properties 102 of a wireless device 100. The processor 125 first determines CSI 108 based on wireless signals 104. The CSI 108 may also be determined based on thermal monitoring data 124 and commissioned layout data 128. The processor may then determine device location properties 102 based on the CSI 108 and the body-mass signature 110 corresponding to the identifier 106 embedded in the wireless signals 104 used to derive the CSI 108. The device location properties 102 may also be based on the thermal monitoring data 124 and the thermal profile 130 corresponding to the identifier 106. The device location properties 102 may include (1) relative location 112 of the wireless device 100 on the subject S and (2) associated subject status 114. The processor 125 may then generate an alarm signal 116 based on the associated subject status 114. The processor 125 may also generate a limit operation signal 132 configured to limit one or more operational aspects 118 of a wireless device 100.

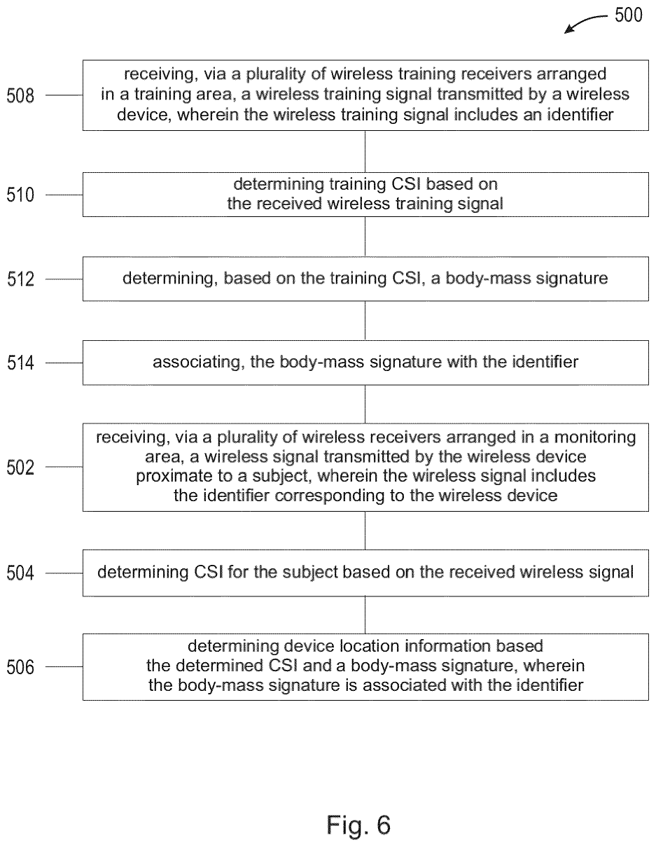

Referring now to FIG. 6, a method 500 for determining one or more device location properties of a wireless device is provided. The method 500 includes receiving 502, via a plurality of wireless receivers arranged in a monitoring area, a wireless signal transmitted by the wireless device proximate to the subject. The wireless signal includes an identifier, such as a Bluetooth identifier, corresponding to the wireless device. The wireless signal may be transmitted by a smartphone in the front pocket or back pocket of a subject. In this example, the subject is a human, though in alternative examples, the subject may be a non-human animal or a device, such as a robot.

The method 500 further includes determining 504 CSI for a subject based on the received wireless signal. CSI is determined by comparing the wireless signals transmitted by the wireless device to the wireless signals received by the receivers. In this example, the CSI represents the body-mass impact of the subject carrying the wireless device on the wireless signal. Accordingly, the CSI acts as an identifier of the subject carrying the device. In some examples, the CSI is determined based on selected wireless signals determined to be transmitted through the body of the subject. This determination may be made through the analysis of thermal monitoring data collected by thermopile monitoring sensors.

The method 500 further includes determining 506 the device location properties based on the determined CSI and a body-mass signature, wherein the body-mass signature is associated with the identifier. A body-mass signature is a representation of the impact of the body of a subject upon wireless signals. Thus, by comparing the determined CSI to the body-mass signature, a number of device location properties may be determined. In one example, an associated subject status of the wireless device may be determined. The associated subject status indicates whether the wireless device is currently being carried by its rightful owner. In other examples, a relative location of the wireless device on the subject (such as front pocket, back pocket, handbag, backpack, etc.) is determined.

According to an example, and with further reference to FIG. 6, the method 500 may further include receiving 508, via a plurality of wireless training receivers arranged in a training area, a wireless training signal transmitted by the wireless device. The wireless training signal includes the identifier. The wireless training signal may be equivalent to the wireless signal described above. The training area may be an entrance way, aisle, stairwell, security checkpoint, or other area where a subject will almost certainly be carrying their wireless device. The training area is used to generate body-mass signatures for the subjects travelling through the training area, and associated the body-mass signatures with identifiers transmitting by the wireless devices carried by the corresponding subjects.

The method 500 may further include determining 510 training CSI based on the received wireless training signal. As with the CSI described about, the training CSI represents the body-mass impact of the subject carrying the wireless device on the wireless training signal. The training CSI may determined based on selected wireless training signals determined to be transmitted through the body of the subject. This determination may be made through the analysis of thermal training data collected by thermopile training sensors.

The method 500 may further include determining 512, based on the training CSI, the body-mass signature. The body-mass signature may be an aggregate of the training CSI corresponding to the most relevant wireless training signals, namely the wireless training signals travelling through the body of the subject.

The method 500 may further include associating 514 the body-mass signature the identifier. This association of the body-mass signature and the identifier may be stored in a database for retrieval during monitoring.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements can optionally be present other than the elements specifically identified within the list of elements to which the phrase “at least one” refers, whether related or unrelated to those elements specifically identified.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

The above-described examples of the described subject matter can be implemented in any of numerous ways. For example, some aspects can be implemented using hardware, software or a combination thereof. When any aspect is implemented at least in part in software, the software code can be executed on any suitable processor or collection of processors, whether provided in a single device or computer or distributed among multiple devices/computers.

The present disclosure can be implemented as a system, a method, and/or a computer program product at any possible technical detail level of integration. The computer program product can include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some examples, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to examples of the disclosure. It will be understood that each block of the flowchart illustrations and/or block diagrams, and combinations of blocks in the flowchart illustrations and/or block diagrams, can be implemented by computer readable program instructions.

The computer readable program instructions can be provided to a processor of a, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various examples of the present disclosure. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Other implementations are within the scope of the following claims and other within the scope of the present disclosure. claims to which the applicant can be entitled.

While various examples have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the examples described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific examples described herein. It is, therefore, to be understood that the foregoing examples are presented by way of example only and that, within the scope of the appended claims and equivalents thereto, examples can be practiced otherwise than as specifically described and claimed. Examples of the present disclosure are directed to each individual feature, system, article, material, kit, and/or method described herein.

1. A system for determining one or more device location properties of a wireless device, the system comprising a processor configured to:
receive, via a plurality of wireless receivers arranged in a monitoring area, a wireless signal transmitted by the wireless device proximate to a subject, wherein the wireless signal includes an identifier corresponding to the wireless device;
determine channel state information for the subject based on the received wireless signal; and
determine the one or more device location properties based on the determined CSI and a body-mass signature, wherein the body-mass signature is associated with the identifier, wherein the body-mass signature corresponds to a body-mass index of one or more subjects.

2. The system of claim 1, wherein one or more device location properties comprises a relative location of the wireless device on the subject.

3. The system of claim 2, wherein the relative location corresponds to one of the a front pocket of the subject, a back pocket of the subject, a handbag of the subject, or a backpack of the subject.

4. The system of claim 1, wherein one or more device location properties comprises an associated subject status indicating whether or not the subject with the wireless device is an owner of the wireless device.

5. The system of claim 4, wherein the processor is further configured to generate an alarm signal based on the associated subject status.

6. The system of claim 4, wherein the processor is further configured to limit one or more operational aspects of the wireless device based on the associated subject status.

7. The system of claim 1, wherein the plurality of wireless receivers are Bluetooth receivers or ultrawideband receivers.

8. The system of claim 1, wherein the processor is further configured to:
receive, via a plurality of wireless training receivers arranged in a training area, a wireless training signal transmitted by the wireless device, wherein the wireless training signal includes the identifier; and
determine training CSI based on the received wireless training signal;
determine, based on the training CSI, the body-mass signature; and
associate the body-mass signature with the identifier of the wireless training signal.

9. The system of claim 8, wherein the processor is further configured to receive thermal training data collected by a thermopile training sensor arranged in the training area or light detection and ranging training data collected by a LIDAR training sensor arranged in the training area.

10. The system of claim 9, wherein the body-mass signature is further based on the thermal training data or the LIDAR training data.

11. The system of claim 1, wherein the one or more device location properties are further based on commissioned layout data corresponding to the plurality of wireless receivers.

12. The system of claim 1, wherein the processor is further configured to receive thermal monitoring data collected by a thermopile monitoring sensor arranged in the monitoring area.

13. The system of claim 12, wherein the one or more device location properties are further based on the thermal monitoring data.

14. A method for determining one or more device location properties of a wireless device, comprising:
receiving, via a plurality of wireless receivers arranged in a monitoring area, a wireless signal transmitted by the wireless device proximate to the subject, wherein the wireless signal includes an identifier corresponding to the wireless device;
determining channel state information for a subject based on the received wireless signal; and
determining the device location properties based on the determined CSI and a body-mass signature, wherein the body-mass signature is associated with the identifier, wherein the body-mass signature corresponds to a body-mass index of one or more subjects.

15. The method of claim 14, further comprising:
receiving, via a plurality of wireless training receivers arranged in a training area, a wireless training signal transmitted by the wireless device, wherein the wireless training signal includes the identifier;
determining training CSI based on the received wireless training signal;
determining, based on the training CSI, the body-mass signature corresponding to the identifier; and
associating the body-mass signature with the identifier of the wireless training signal.
